(19) United States
(12) Patent Application Publication
(10) Pub. No.: US 2016/0228733 A1
(43) Pub. Date: Aug. 11, 2016

(54) Extended Fire Hose System

(71) Applicant: John Ceresani, Cherry Hill, NJ (US)

(72) Inventor: John Ceresani, Cherry Hill, NJ (US)

(21) Appl. No.: 15/017,614

(22) Filed: Feb. 6, 2016

Related U.S. Application Data
(60) Provisional application No. 62/113,346, filed on Feb. 6, 2015.

(51) Int. Cl. A62C 31/24; A62C 33/04

(52) U.S. Cl. CPC A62C 31/24; A62C 33/04

(57) ABSTRACT

An extended fire hose system for directing firefighting fluids to a fire from a fire hose is provided. The extended fire hose system comprises a first pipe having an open first end and an open second end with the first end of the first pipe capable of being connected to the fire hose. A nozzle is connectable to the open second end of the first pipe. A motor is mounted adjacent the first end of the first pipe for moving the nozzle. The nozzle delivers firefighting fluids to a desired position for effective firefighting while minimizing risks to firefighters and saving fire lives.

### CLAIM OF PRIORITY

This patent application claims priority under 35 USC 119 (e) (1) from U.S. Provisional Patent Application Ser. No. 62/113,346 filed Feb. 6, 2015, of common inventorship herewith entitled, “Fire Hose System,” which is incorporated herein by reference as though the same were set forth in its entirety.

### FIELD OF THE INVENTION

The present invention pertains to the field of fire equipment, and more specifically to the field of fire hose attachments.

### BACKGROUND OF THE INVENTION

Firemen have used water hoses to fight fires for more than two thousand years, since hoses were made of oxen hide and filled with water from oxen hide bags. Pressure in the hose came from men stomping on the oxen hide bags thus forcing a stream of water through the hose. Firefighting next evolved into a bucket brigade technique although hand pumped fire engines equipped with nozzles soon allowed for using hoses that were constructed of leather strips stitched together and measured approximately fifty feet in length. In early years of the eighteen hundreds, members a fire hose company invented a way to rivet the seams of leather hoses which provided increased resistance against rupture. These hoses were approximately forty to fifty feet in length, contained metal couplings for long relaying capability and weighed approximately eighty five pounds apiece. Vulcanized rubber was invented subsequently, resulting in stronger, somewhat lighter and more flexible hoses. Firefighters discovered that rubber hoses performed better when sheathed in a cotton fabric webbing. In later years of the eighteen hundreds, vulcanized rubber was discarded entirely in favor of woven cotton fire hoses which were standardized at approximately seven thousand one hundred and two threads per seamed inch. The modern fire hose currently utilized by professional fire fighters is a result of continuous improvement by using newer and more lightweight weaves.

Standard firefighting hoses are approximately one and one half inches in diameter. The nozzles which control and direct a high pressure flow of water or foam are sophisticated instruments that deliver a stream, spray or fog at a pressure of approximately one hundred pounds per square inch. Even when using the best equipment, the fact remains that the hose nozzle is handled by a firefighter who is a human whose mobility is necessarily restricted by concern for his life. What firefighters need is a means of reaching a burning structure's interior and projecting the water or foam where it will do the most good while remaining as safe as possible.

The prior art has put forth several designs for fire hose attachments. Among these are:

U.S. Pat. No. 4,697,740 to Eugene W. Ivy describes a mist generating nozzle having a cylindrical bearing member in which a plurality of distribution slots are formed. A cylindrical sleeve member is concentrically disposed about the bearing member, with an annular chamber defined there between. The sleeve member has a plurality of orifices communicating with the annular chamber and extending transversely with respect to the radius of the sleeve member for imparting rotational motion to the sleeve member in response to the discharge of water through the orifices. The centrifugal force acting on the water discharged through the orifices particulates the water droplets into a fine mist or fog, in a substantially spiral pattern around the nozzle. In another aspect of the invention, the mist generating nozzle is incorporated into a firefighting tool, which includes a piercing member for penetrating a building structure.

U.S. Pat. No. 2,246,797 to John W. Geddes describes a fire fighting apparatus with an object to provide a device for attachment to a hose line whereby effective streams of water are instantaneously introduced into the interior spaces of building structures to combat fires therein. The provided nozzle which in itself constitutes a breaching tool adapted to be manhandled to force the discharge end of the pipe through obstructions into hollow spaces.

U.S. Pat. No. 674,343 to Elbridge W. Oakes describes a hose nozzle especially adapted for penetrating walls of buildings that are afire, driving through partitions for quenching fire in adjacent rooms or burrowing into debris, coal piles or bunkers of ships and extinguishing fires in them or in similar places situated so as to be inaccessible to an ordinary fire stream. One object of this invention is to provide a hose nozzle that is simple in construction and capable of being driven through partitions or into masses of burning fuel without danger of clogging the nozzle opening or throttling the stream. A further object is to provide a detachable driving point that protects the nozzle end while being driven and will automatically detach itself from the nozzle when the water is turned on, thus ensuring free discharge. The point remains embedded in the coal of a bunker that is afire and forms a protection for the nozzle end, while permitting unobstructed flow of water from the nozzle through the mass of coal.

None of these prior art references describe the present invention.

### SUMMARY OF THE INVENTION

It is an object of the present invention to provide a set of special purpose nozzles and extender pipes to be connected to standard fire hoses by firefighters.

The present invention is an extended fire hose system for directing firefighting fluids to a fire from a fire hose. The extended fire hose system comprises a first pipe having an open first end and an open second end with the first end of the first pipe capable of being connected to the fire hose. A nozzle is connectable to the open second end of the first pipe. A motor is mounted adjacent the first end of the first pipe for moving the nozzle. The nozzle delivers firefighting fluids to a desired position for effective firefighting while minimizing risks to firefighters and saving fire lives.

In addition, the present invention includes a method for directing firefighting fluids to a fire from a fire hose. The method comprises providing a first pipe having an open first end and an open second end, connecting the first end of the first pipe to the fire hose, connecting a nozzle to the open second end of the first pipe, mounting a motor adjacent the first end of the first pipe for moving the nozzle, delivering firefighting fluids to a desired position for effective firefighting while minimizing risks to firefighters and saving fire lives.

The present invention further includes an extended fire hose system for directing firefighting fluids to a fire from a fire hose. The extended fire hose system comprises a first pipe having an open first end and an open second end with the first end of the first pipe capable of being connected to the fire hose. A nozzle is connectable to the open second end of the first pipe. A motor is mounted adjacent the first end of the first pipe for moving the nozzle. A camera is mounted to or nearingly adjacent the nozzle. A heat sensor mechanism is mounted to or nearingly adjacent the nozzle. The nozzle delivers firefighting fluids to a desired position for effective firefighting while minimizing risks to firefighters and saving fire lives.

### BRIEF DESCRIPTION OF THE DRAWINGS

FIG. 1 is an elevational side view illustrating an aluminum cylindrical rod of an extended fire hose system constructed in accordance with the present invention, containing an attached camera and heat sensor;

FIG. 1a is an elevational side view illustrating a diagrammed close up view of the pointed and piercing terminal end of the rod of the extended fire hose system constructed in accordance with the present invention.

FIG. 2 is a perspective view illustrating the extended fire hose system constructed in accordance with the present invention, with the fire hose system attached to a fire hose on a fire truck that contains a hydraulic motor which is operated by a firefighter on ground or truck level.

FIG. 3 is a top down perspective views illustrating an aluminum cylindrical rod of the extended fire hose system constructed in accordance with the present invention, with the cylindrical rod containing a pointed and piercing terminal end and is flanked by several aluminum cylindrical rods that are extra extensions available for creating more functional length.

FIG. 4 is a close up diagonal view illustrating a motor of the extended fire hose system constructed in accordance with the present invention, with the motor attached between a fire hose and aluminum rod with its purpose being to move the rod and any attached rods in or out the burning space.

FIG. 5 shows a perspective view illustrating a platform of the extended fire hose system constructed in accordance with the present invention, with the platform mountable to a side or rear of a fire truck wherein the platform comprises means for raising and lowering the extension rod and nozzle.

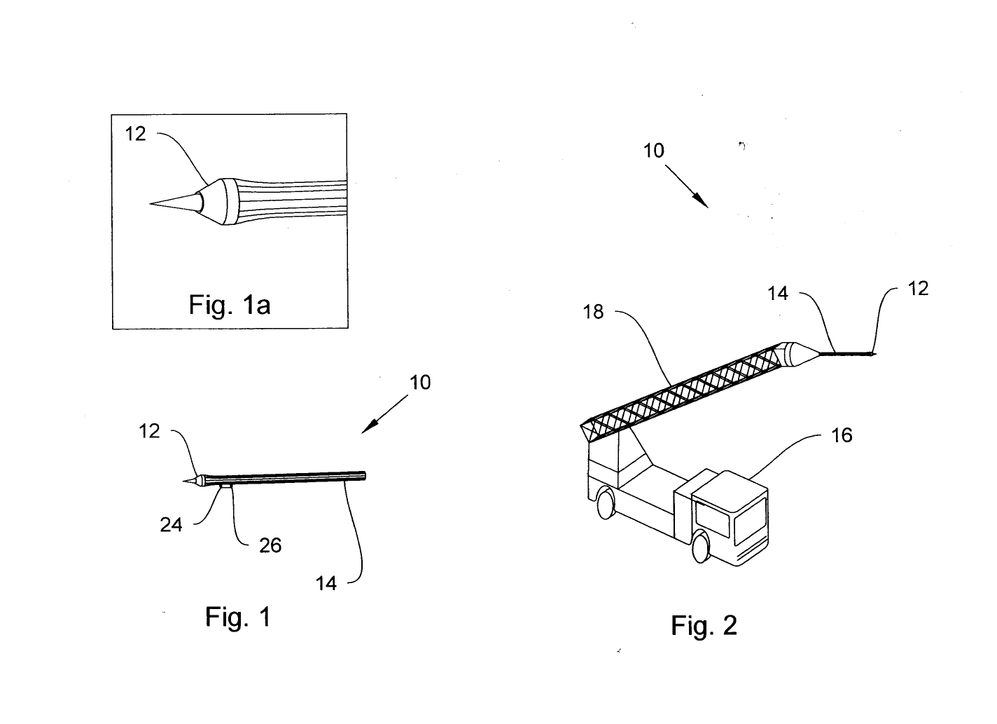

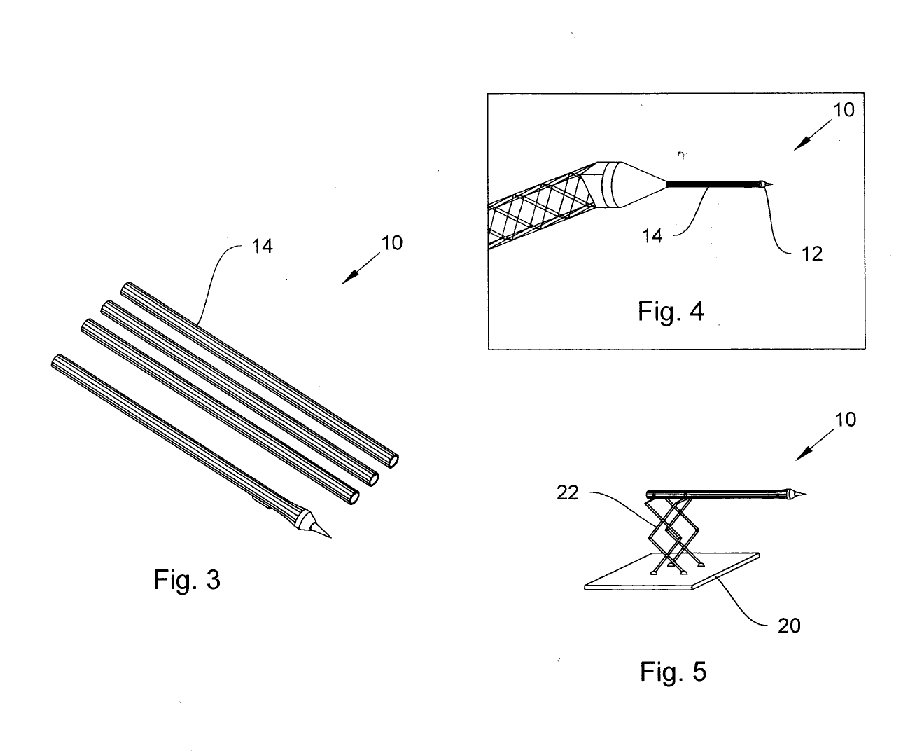

### DETAILED DESCRIPTION OF THE INVENTION

The present invention, hereinafter referred to as an Extended Fire Hose System, indicated generally at 10, is a set of special purpose nozzles 12 and extender pipes 14 to be used with standard fire hoses to provide a safer means for firefighter to direct high pressure water flow or foam into a burning structure. Additionally, the Extended Fire Hose System 10 can be mounted to the side or rear of the fire truck 16 and/or on a boom 18 with the pipes 14 and nozzle 12 raised on a rotatable platform 20 to access heretofore unreachable areas.

The Extended Fire Hose System 10 of the present invention motorized system enables firefighters to achieve a straight line extension of up to approximately forty five feet, the end of which is a spherical, high powered, sprinkler head nozzle. The aforementioned configuration permits firefighters to successfully reach and fight fires in the interiors of structures at far less risk to themselves.

In an embodiment, the Extended Fire Hose System 10 of the present invention can be mounted to a platform 20 mounted to a side or rear of a fire truck 16 wherein the platform 20 comprises means for raising and lowering the extension rod. Means for raising and lowering the extension rod 14 and nozzle 12 can be by any suitable means, such as a scissor jack 22, or hydraulic lift, for example.

In an additional embodiment, the platform 20 onto which the Extended Fire Hose System 10 of the present invention is mounted can be rotated at least forty-five degrees by means of a turntable supporting the platform 20.

The nozzle end 12 of the Extended Fire Hose System 10 of the present invention can pierce a structure to penetrate a wall for insertion of the hose nozzle 12 into a structure. Additionally, the Extended Fire Hose System 10 can include a camera 24 secured to either the extender pipe 14 or the nozzle 12 for remote viewing.

The hose attached to the nozzle 12 can be one inch diameter. The extended rod 14 can extend to forty feet or twenty feet and have a counter balance to balance the weight of the extended rod 14 and preserve the integrity of the device.

The Extended Fire Hose System 10 of the present invention includes a system of rigid high pressure aluminum pipes 14 engineered to extend a standard, approximately one and one half inch, firefighting hose in approximately twenty foot sections with the final section terminating in an extra wide angled, spherical spray head nozzle 12. Each of the twenty foot sections is equipped with high pressure, twist and lock fittings. Also, the rods 14 can be telescopingly assembled allowing extension of the Extended Fire Hose System, as desired. The nozzle 12 and sprinkler head section, which is connected directly to a fire hose or to one of the other extender pipes 14, preferably comprises a machined brass nozzle with a spherical spray head.

The Extended Fire Hose System 10 of the present invention is employable to reach the interior of a burning structure. To this end, the assembled apparatus is motorized using hydraulics and navigate into the structure by firefighters using a heat sensor 26 and the camera 24. The heat sensor 26 and the camera 24 are mounted on the penetrating rod 14 and/or the nozzle 12 and controlled from the ground or fire truck 16. Firefighters estimate the distance to be covered and using the motorized system, extend the rods 14 or sections of the Extended Fire Hose System 10 of the present invention as needed. Containing a rigid, pointed and piercing distal component, the end of the water nozzle 12 is sufficiently heavy duty and reinforced to be thrust through walls where necessary.

Once the Extended Fire Hose System 10 of the present invention is positioned in a highly functional and effective place where the terminal spray nozzle 12 provides maximum coverage, the apparatus is energized with water or foam. The water or foam sprays in all directions from the nozzle 12, providing ample coverage in areas otherwise inaccessible to firefighters, at a dramatically reduced risk to the firefighters. The Extended Fire Hose 10 is specifically constructed to reach and fight fires extremely effectively while minimizing risks to firefighters and saving fire victim's lives.

Although the Extended Fire Hose System of the present invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. An extended fire hose system for directing firefighting fluids to a fire from a fire hose, the extended fire hose system comprising:
a first pipe having an open first end and an open second end, the first end of the first pipe capable of being connected to the fire hose;
a nozzle connectable to the open second end of the first pipe; and
a motor mounted adjacent the first end of the first pipe for moving the nozzle;
wherein the nozzle delivers firefighting fluids to a desired position for effective firefighting while minimizing risks to firefighters and saving fire lives.

2. The extended fire hose system of claim 1 and further comprising:
a second pipe having a first end and a second end, the first end of the second pipe fluidly connected to the second end of the first pipe;
wherein the nozzle is connectable to the second end of the second pipe.

3. The extended fire hose system of claim 2 and further comprising:
“n” number of pipes between the first pipe and the second pipe, each pipe having a first end and a second end, the first end of each pipe connected to the second end of an adjacent pipe.

4. The extended fire hose system of claim 2 wherein the first end of the second pipe is telescopically received within the second end of the first pipe.

5. The extended fire hose system of claim 4 and further comprising:
“n” number of pipes between the first pipe and the second pipe, each pipe having a first end and a second end, the first end of each pipe telescopically received within the second end of an adjacent pipe.

6. The extended fire hose system of claim 1 and further comprising:
a camera mounted to or nearingly adjacent the nozzle.

7. The extended fire hose system of claim 1 and further comprising:
a heat sensor mechanism mounted to or nearingly adjacent the nozzle.

8. The extended fire hose system of claim 1 wherein the first end of the first pipe is mounted to a boom on a fire truck.

9. The extended fire hose system of claim 1 and further comprising:
a rotatable platform mounted to the boom, the first end of the first pipe mounted to the rotatable platform.

10. The extended fire hose system of claim 9 and further comprising:
a moving mechanism mounted on the platform for raising and lowering the first pipe.

11. The extended fire hose system of claim 10 wherein the moving mechanism is selected from the group consisting of a scissor jack and a hydraulic lift.

12. The extended fire hose system of claim 1 wherein the nozzle has a pointed end.

13. A method for directing firefighting fluids to a fire from a fire hose, the method comprising:
providing a first pipe having an open first end and an open second end;
connecting the first end of the first pipe to the fire hose;
connecting a nozzle to the open second end of the first pipe;
mounting a motor adjacent the first end of the first pipe for moving the nozzle; and
delivering firefighting fluids to a desired position for effective firefighting while minimizing risks to firefighters and saving fire lives.

14. An extended fire hose system for directing firefighting fluids to a fire from a fire hose, the extended fire hose system comprising:
a first pipe having an open first end and an open second end, the first end of the first pipe capable of being connected to the fire hose;
a nozzle connectable to the open second end of the first pipe;
a motor mounted adjacent the first end of the first pipe for moving the nozzle;
a camera mounted to or nearingly adjacent the nozzle; and
a heat sensor mechanism mounted to or nearingly adjacent the nozzle;
wherein the nozzle delivers firefighting fluids to a desired position for effective firefighting while minimizing risks to firefighters and saving fire lives.

15. The extended fire hose system of claim 14 and further comprising:
a second pipe having a first end and a second end, the first end of the second pipe fluidly connected to the second end of the first pipe;
wherein the nozzle is connectable to the second end of the second pipe.

16. The extended fire hose system of claim 15 and further comprising:
“n” number of pipes between the first pipe and the second pipe, each pipe having a first end and a second end, the first end of each pipe connected to the second end of an adjacent pipe.

17. The extended fire hose system of claim 15 wherein the first end of the second pipe is telescopically received within the second end of the first pipe.

18. The extended fire hose system of claim 17 and further comprising:
“n” number of pipes between the first pipe and the second pipe, each pipe having a first end and a second end, the first end of each pipe telescopically received within the second end of an adjacent pipe.

19. The extended fire hose system of claim 14 wherein the first end of the first pipe is mounted to a boom on a fire truck, and further comprising:
a rotatable platform mounted to the boom, the first end of the first pipe mounted to the rotatable platform.

20. The extended fire hose system of claim 19 and further comprising:
a moving mechanism mounted on the platform for raising and lowering the first pipe;
wherein the moving mechanism is selected from the group consisting of a scissor jack and a hydraulic lift.
